(19) United States
(12) Patent Application Publication
(10) Pub. No.: US 2008/0017769 A1
(43) Pub. Date: Jan. 24, 2008

(54) Vacuum mountable display device

(75) Inventors: Douglas M. Sheffield, Chesterfield, MO (US); Tamara K. Sheffield, Chesterfield, MO (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: We-Flex, LLC

(21) Appl. No.: 11/491,592

(22) Filed: Jul. 24, 2006

(51) Int. Cl. F16B 47/00

(52) U.S. Cl. 248/206.2

(57) ABSTRACT

A display device mountable by suction on a generally smooth mounting surface. The display device includes a deformable body having an outer surface, an inner surface having a concave portion, and a periphery extending around the body and surrounding the outer and inner surfaces. The body is deformable from an undeformed shape to an actuated shape to mount the device on the mounting surface by positioning the inner surface of the body adjacent the mounting surface when the body is in its undeformed shape thereby forming a cavity between the body and the mounting surface and deforming the body to its actuated shape thereby sealing the body against the mounting surface and forcing fluid out of the cavity to create a suction between the body and the mounting surface thereby securing the body to the mounting surface The device further includes a display formed on the body including an image.

### BACKGROUND OF THE INVENTION

The present invention relates to display devices and, more specifically, to portable display devices that are vacuum mounted on smooth surfaces.

Conventional display items include posters, baseball cards, and artistic paintings. Most conventional display items are not self-mountable on surfaces such as walls or windows. That is, most display items require an intermediary or agent, such as glue, tacks, or an item holder such as a picture frame in order to be mounted on surfaces. Mounting items on surfaces using an intermediary has various drawbacks. It is usually not easy to relocate items mounted on surfaces using intermediaries to other surfaces. For example, a poster glued or plastered to a wall cannot be easily removed. Mounting items on surfaces by way of tacks, staples, or most conventional fasteners leave unwanted marks on the mounting surface and sometimes on the item when they are demounted. For example, to change the display location of a conventional picture frame, the frame must be removed from a hook on which it was hanging from and a hook must be mounted on a wall at another location for holding the frame. The old hook must be used for other purposes or removed, which could leave a scar in the wall and require repair and painting.

Item holders with better portability exist, but they have limited convenience. For example, magnetic picture frames are easily portable from one ferrous surface to another. However, such picture frames will not work where the surface is not ferrous. Conventional suction cups are very portable, being mountable on most generally smooth and non-porous surfaces. However, most conventional suction cups do not display graphics themselves. Rather, many conventional suction cups include knobs extending from an outer surface of the suction cup for hanging items containing graphics on. However, conventional suction cups, like other mounting intermediaries, must be procured and connected to the item for securing the item to the surface. Further, some intermediaries, such as most conventional suction cups, sometimes become separated from the item, leaving the item not mounted and possibly resulting in the item and/or the intermediary being lost.

A conventional self-mountable display device exists including a thin film of material, such as plastic, that adheres to many surfaces by static cling. The material of these devices is decorated with a desired graphic. Such static-mounted devices have various drawbacks. One drawback is limited mounting durations. Another drawback of static-mounted devices is that they sometimes leave residue on the mounting surface, such as pieces of the thin film, when removed from the mounting surface after being mounted for extended periods of time. Portable display devices including desired graphics are sought that are self-mountable on surfaces for long periods of time without leaving residue upon removal.

### BRIEF SUMMARY OF THE INVENTION

The present invention relates to a display device mountable by suction on a generally smooth mounting surface. The display device includes a deformable body having an outer surface, an inner surface having a concave portion opposite the outer surface, and a periphery extending around the deformable body and surrounding the outer surface and the inner surface. The body is deformable from an undeformed shape to an actuated shape to mount the display device on the mounting surface by positioning the inner surface of the body adjacent the mounting surface when the body is in its undeformed shape thereby forming a cavity between the body and the mounting surface and deforming the body to its actuated shape thereby sealing the body against the mounting surface and forcing fluid out of the cavity to create a suction between the body and the mounting surface thereby securing the body to the mounting surface The display device further includes a display formed on the deformable body including an image.

In another aspect, the present invention relates to a display device mountable by suction on a generally smooth mounting surface. The display device includes a deformable body having an outer surface, an inner surface having a concave portion opposite the outer surface, and a periphery extending around the deformable body and surrounding the outer surface and the inner surface. The body is deformable from an undeformed shape to an actuated shape to mount the display device on the mounting surface by positioning the inner surface of the body adjacent the mounting surface when the body is in its undeformed shape thereby forming a cavity between the body and the mounting surface and deforming the body to its actuated shape thereby sealing the body against the mounting surface and forcing fluid out of the cavity to create a suction between the body and the mounting surface thereby securing the body to the mounting surface. The display device further includes a display having a front component formed on the outer surface of the deformable body, the front component relating to a theme.

In yet another aspect, the present invention relates to a display device mountable by suction on a generally smooth mounting surface. The display device includes a deformable body having an outer surface, an inner surface having a concave portion opposite the outer surface, and a periphery extending around the deformable body and surrounding the outer surface and the inner surface. The body is deformable from an undeformed shape to an actuated shape to mount the display device on the mounting surface by positioning the inner surface of the body adjacent the mounting surface when the body is in its undeformed shape thereby forming a cavity between the body and the mounting surface and deforming the body to its actuated shape thereby sealing the body against the mounting surface and forcing fluid out of the cavity to create a suction between the body and the mounting surface thereby securing the body to the mounting surface. The display device further includes a display having a back component formed on the inner surface of the deformable body. The back component relates to a theme.

Other aspects of the present invention will be in part apparent and in part pointed out hereinafter.

### BRIEF DESCRIPTION OF THE DRAWINGS

FIG. 1A is a front elevation of a display device according to a first embodiment of the present invention.

FIG. 1B is a rear elevation of the display device of FIG. 1A.

FIG. 2 is a cross section of the display device taken along line 2-2 of FIG. 1A shown in an undeformed shape adjacent a mounting surface.

FIG. 3 is a cross section of the display device of FIG. 2 shown in an actuated shape secured to the mounting surface.

FIG. 4A is a front elevation of a display device according to a second embodiment of the present invention.

FIG. 4B is a rear elevation of the display device of FIG. 4A.

FIG. 5A is a front elevation of a display device according to a third embodiment of the present invention.

FIG. 5B is a rear elevation of the display device of FIG. 5A.

Corresponding reference characters indicate corresponding parts throughout the several views of the drawings.

### DETAILED DESCRIPTION OF THE INVENTION

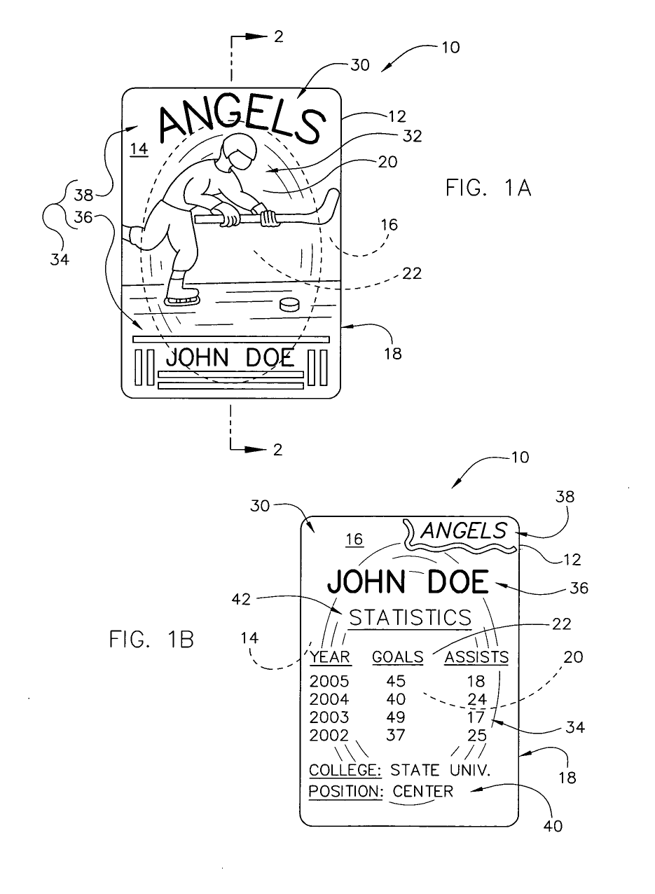

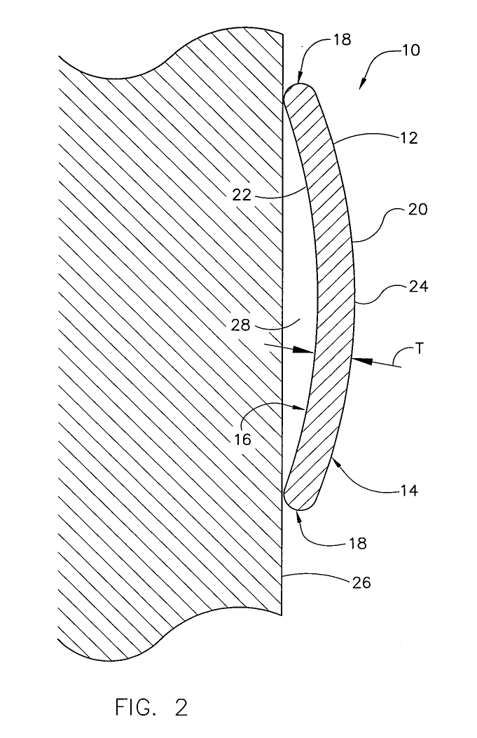

Referring to the figures, and more particularly to FIG. 1A, a portable display device according to a first embodiment of the present invention is designated in its entirety by reference number 10. The display device 10 has a flexible or deformable body 12 including an outer surface 14, an inner surface 16, and a periphery 18 extending around the body and surrounding the inner surface and the outer surface. Although the flexible body 12 may include other materials without departing from the scope of the present invention, in one embodiment the body includes a resinous thermoplastic such as polyvinyl chloride. The flexible body 12 may be generally visually transparent, translucent, or opaque. As shown in FIG. 2, the outer surface 14 may include a convex portion 20. The inner surface 16 includes a concave portion 22 opposite the outer surface 14. For embodiments in which the outer surface 14 includes the convex portion 20, the concave portion 22 of the inner surface 16 may be opposite the convex portion. The outer surface 14 may be substantially free of protrusions such as the central knobs protruding from outer surfaces of conventional suction cups. In one embodiment, the convex portion 20 is substantially free of protrusions. The flexible body has a thickness T measured between the outer surface 14 and the inner surface 16. The thickness T may vary throughout the flexible body 12 or be generally constant. For example, the thickness T may vary from a maximum thickness of between about 0.10 inch and about 0.25 inch in a central region 24 of the convex and/or concave portions 20, 22 and a minimum thickness of between about 0.04 inch and about 0.08 inch adjacent the periphery 18. In one embodiment, the flexible body 12 has a constant thickness T of between about 0.08 inch and about 0.13 inch.

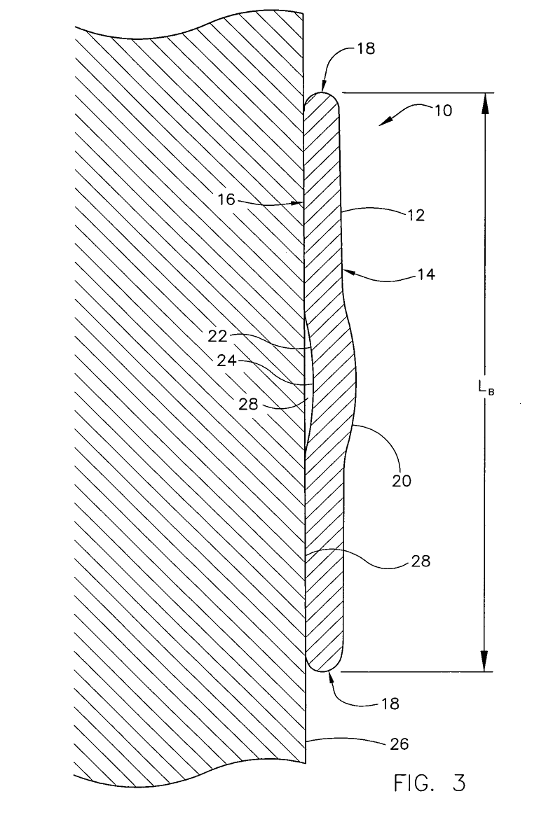

The flexible body 12 is deformable between an undeformed or default shape, shown in FIG. 2, and an actuated shape, shown in FIG. 3, to mount the display device 10 by suction or vacuum on a generally smooth and generally non-porous mounting surface 26. The display device 10 may be secured to mounting surfaces 26 having various attitudes. For example, the display device 10 may be mounted on an upward facing or downward facing horizontal mounting surface 26. The display device 10 may also be mounted on a vertical surface 26 or on a generally upward or downward facing surface that is angled between horizontal and vertical. A mounting strength of the display device 10 depends in part on the size, shape, and material of the body 12 and characteristics of the mounting surface 26, such as smoothness and porosity.

The mounting surface 26 must include a surface area that is at least as large as an area the flexible body 12 spans when it is in its actuated shape. To mount the display device 10 on the mounting surface 26, the inner surface 16 of the flexible body 12 is positioned adjacent the mounting surface when the body is in its default shape, as shown in FIG. 2. By positioning the flexible body 12 in this way, a cavity 28 is formed between the body 12 and the mounting surface 26. Then the flexible body 12 is moved to its actuated shape (i.e., causing the inner surface 16 to conform to the mounting surface), as shown in FIG. 3, thereby sealing the body against the mounting surface 26 and forcing fluid such as air out of the cavity 28 to create the suction between the body and the mounting surface. The suction created within the sealed cavity secures the body 12 to the mounting surface 26. As the flexible body 12 is deformed toward the actuated shape, reflex or spring forces are created in the body between the convex and concave portions 20, 22 that act to return the body to its default shape. As will be appreciated by those skilled in the art, the flexible body 12 must be sized and shaped so forces created by the suction balance with or are greater than the sum of the reflex forces created in the body and any loading on the body to create and maintain the connection between the body and mounting surface 26. To demount the body 12 from the mounting surface, the user moves the body out of its actuated shape thereby breaking the seal and suction. For example, the user may pull or otherwise move a portion of the periphery 18 to break the suction and seal.

The periphery 18 of the flexible body 12 may have various sizes and shapes without departing from the scope of the present invention, as long as the suction between the display device 10 and the mounting surface 26 can be created and maintained as described above. For some periphery 18 shapes, the reflex forces in the body 12 must be reduced in places to ensure secure mounting of the display device 10 on the mounting surface 26. One way to reduce reflex forces is by selectively changing body 12 thickness T. For example, the thickness T of the flexible body 12 may taper from a maximum thickness adjacent the central region 24 of the convex and concave portions 20, 22 to a minimum thickness adjacent the periphery 18, as described above, to reduce reflex forces. It is contemplated that reflex forces can also be reduced by varying the material or material properties of the flexible body 12 between the central region 24 and the periphery 18. Another way to reduce reflex forces in the body 12 is to make the body to have a bend (not shown) between the concave portion 22 and the periphery 18 so the inner surface 16 of the body turns away from the mounting surface 26 when the display device 10 is positioned adjacent the mounting surface.

The periphery 18 may be symmetric, such as circular, square, or oval, or non-symmetric. In one embodiment, the periphery 18 is non-circular. Other exemplary periphery 18 shapes include those corresponding to articles of clothing such as a shirt or shoe, structures such as a house or skyscraper, a vehicle such as a car, boat, or airplane, and articles of natures such as a fruit, flower, tree, person, or animal. The display device 10 shown in FIG. 1A has a generally rectangular-shaped periphery 18.

In one embodiment, the flexible body 12 has a maximum length LB (shown in FIG. 3) between about 3 inches and about 3.5 inches. In some embodiments, the body 12 has a maximum length LB of about 4 inches or larger. In a particular embodiment, the flexible body 12 has a maximum length of between about 3.25 inches and about 3.75 inches allowing the device 10 to easily fit into a standard wallet or similarly sized compartment for storage or display.

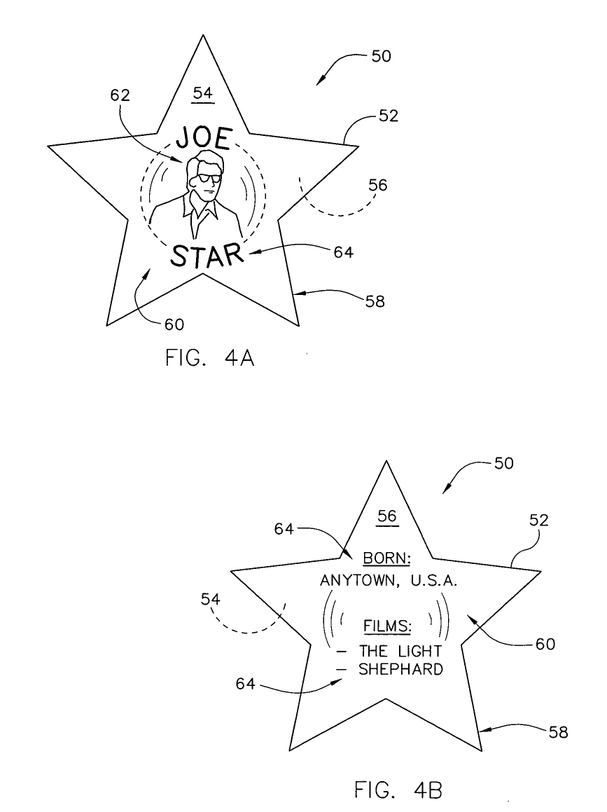

The flexible body 12 may be colored or tinted as desired. For example, a star-shaped display device (shown in FIG. 4A) may be colored white or yellow, a heart-shaped display device (not shown) may be colored red, and a tree-shaped display device (not shown) may be colored green and/or brown.

As shown in FIGS. 1A and 1B, the display device 10 further includes an object or display 30 formed on the outer surface 14 of the flexible body 12, on the inner surface 16 of the body, and/or between the inner surface and the outer surface. The display 30 may be formed on the flexible body 12 for communication and/or aesthetic purposes. In some embodiments, the display device 10 is substantially free of parts other than the flexible body 12 and the display 30 formed thereon. Devices 10 according to those embodiments are said to be unitary because they comprise a single body 12 and are substantially free of parts other than the body and display 30 formed thereon, such as adhesives, magnets, or stiff placards that are a part of some conventional display devices.

The display device 10 may include a variety of displays 30 without departing from the scope of the present invention. For example, the display 30 can include art, messages such as an advertisement, a story, instructions, or directions or representations of people, places, and things such as animals, plants, and architectural structures (e.g., a house). The types of displays 30 that can be formed on the body 12 are not limited. In one embodiment, the display 30 includes an image of an individual 32 such as a fictional person or an actual person. Exemplary actual persons include the current and past presidents of the United States. Fictional or made-up individuals include most cartoon characters. In some embodiments, the display 30 includes a cartoon-type portrayal of an actual person. FIG. 1A shows the display 30 including an ice hockey player as the individual 32. Other exemplary individuals 32 include famous athletes, actresses, and actors. The display 30 may include a likeness of a person using the display device 10 as an advertising tool similar to a manner people commonly use business cards. Thus, a user of the display device 10 may give the device to others for identification or advertising or other business purposes.

The display 30 may also include information 34. For embodiments of the display device 10 in which the display 30 includes an individual 32, the information 34 may be related to the individual. The information 34 related to the individual 32 may describe, refer to, or otherwise concern the individual. The information 34 may closely relate to the individual 32, such as by including a name of the individual, or be more distantly related to the individual. FIG. 1A shows information 34 related to the individual 32 including a name 36 of the individual and a team or organization 38 of the individual. As another example of information 34 related to the individual 32, when the individual 32 includes the likeness of a person using the display device 10 as an advertising tool as described above, the information may include data about the person or a business of the person such as their service or product offerings and contact data.

The display 30 may be formed on the flexible body 12 in various ways without departing from the scope of the present invention. As described above, the display 30 may be formed on the outer surface 14, on the inner surface 16, and/or between the outer surface and the inner surface. Exemplary manners of forming the display 30 on the body 12 include printing or painting the display on the body and selectively doping the body, such as with ink having any desired color. The display 30 may also be printed on a label (not shown in detail) adhered to the outer surface 14 of the flexible body 12. The label may be fully or partially opaque, translucent, or transparent as desired. It is contemplated that the display 30 may also be formed on the flexible body 12 using material of the body. For example, the display 30 may be molded, melted, etched, engraved, or impressed into the outer surface 14 of the body 12.

For embodiments of the display device 10 in which the display 30 is formed on the outer surface 16 and on the inner surface 14, the individual 32 may be formed on the outer surface, as shown in FIG. 1A, and all or some of the information 34 may be formed on the inner surface, as shown in FIG. 1B. As described above, the information 34 may be related to the individual 32. The information 34 shown on the inner surface 16 in FIG. 1B includes a position or role 40 that the individual has on the identified team 38. Additional examples of information 34 related to the individual 32 include statistical information 42, such as biographical or accomplishment data. For example, the information 34 may include performance statistics when the individual 32 is an athlete. The information 34 may also include a story, which may relate to the individual 32. In one embodiment, the individual 32 is formed on the inner surface 16 and information 34 about the individual is formed on at least the outer surface 14.

As described above, the periphery 18 of the flexible body 12 may have various shapes without departing from the scope of the present invention. In one embodiment, the periphery 18 has a shape corresponding to a shape or other quality of the display 30. For example, the periphery 18 may be shaped as a football when the display individual 32 is a football player. As another example (not shown), the individual 32 may be a cartoon character and the periphery 18 may be shaped as the individual 32. In this example, the periphery 18 may be shaped as a portion of the character such as being shaped as a head of a cartoon character having a distinctive head shape (e.g., including distinctively shaped ears). As yet another example of the periphery shape corresponding to the display 30, in one embodiment (not shown) the display includes a professional athlete and the periphery is shaped as a player of the respective sport. For example, the periphery 18 may be shaped as a person ice skating and holding a hockey stick when the individual is a hockey player.

The shape of the flexible body 12, the color of the body, and qualities of the display 30 (or any subset of the body shape, the body color, and qualities of the display) may be selected to relate to each other. For example, in one embodiment (not shown), a golf ball inspired display device has a white body, a generally circular periphery, and a display including actual dimples or a rendition of dimples printed or otherwise displayed on the outer surface 14 of the body. Further, the display 30 may be colored or tinted as desired.

The display device 10 may be used in various ways without departing from the scope of the present invention. As described above, to use the display device 10, a user mounts the device on a generally smooth and generally non-porous mounting surface 26. Exemplary uses of the display device 10 include displaying a display 30 formed on the device on a home refrigerator, window, or mirror. The user can also display the display 30 formed on the device 10 on a smooth surface 26 at work or elsewhere. A benefit of the present invention is flexibility to relocate the display device 10 on generally any smooth and non-porous mounting surface 26 as desired. For this reason, the display device 10 is said to be portable. When the display device 10 includes a display 30 as described above and the display is formed on the outer surface 14 or the flexible body 12 is generally translucent or transparent, the display can be viewed direction on the outer surface or through the outer surface when the device is mounted on the mounting surface 26. When the display device 10 includes a display 30 formed on the inner surface 16 or the flexible body 12 is generally translucent or transparent, the display can be viewed through a transparent mounting surface 26 such as a window when the device is mounted on the transparent surface.

As describe above, securing the display device 10 to the mounting surface 26 includes positioning the inner surface 16 of the flexible body 12 adjacent the mounting surface while the body is in its default shape thereby forming the cavity 28 (shown in FIG. 2) between the body and the mounting surface. Then, the flexible body 12 is moved to its actuated shape thereby sealing the body against the mounting surface 26 and forcing fluid such as air out of the cavity 28 to create a suction between the flexible body and the mounting surface. Sealing the suction between the flexible body 12 and the mounting surface 26 secures the body to the mounting surface. To demount the flexible body 12 from the mounting surface 26, for example to relocate the display device 10 on another smooth mounting surface or to give to another person for remounting the device, the body is moved out of its actuated shape thereby breaking the seal and suction. To break the seal and move the body 12 out of its actuated shape, the user may move or pull on a portion of the periphery 18.

FIGS. 4A and 4B show a portable display device 50 according to another embodiment of the present invention. The display device 50 according to this embodiment comprises a flexible body 52 having an outer surface 54, an inner surface 56, and a periphery 58. The display device 50 further comprises a display 60 including an individual 62 that is a selected person (e.g., a student of the month at a school) or a famous person such as a movie star. In this embodiment, the periphery 58 is shaped as a star corresponding to the star or famous individual 62 displayed on the body 52. The display 60 according to this embodiment may also include information 64 related to the individual 62. For example, the display 60 may include statistical information 64 such as biographical or accomplishment data about the individual 62. This embodiment shows still another example of a display device having a periphery shape corresponding to the shape or other quality of the object. The display device 50 of this embodiment is otherwise identical to display devices of earlier described embodiments and therefore will not be described in further detail.

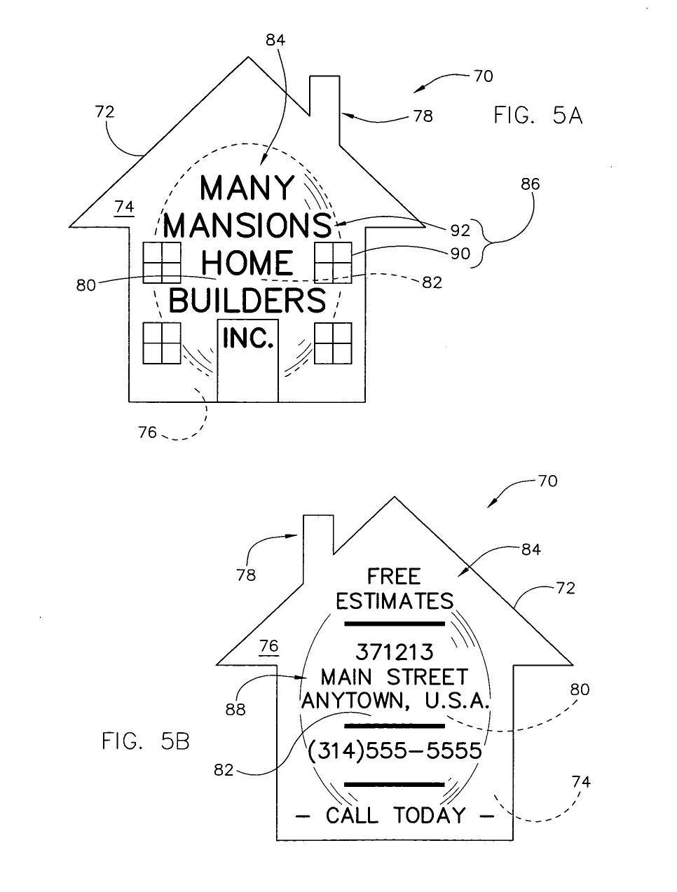

FIGS. 5A and 5B show a portable display device 70 according to another embodiment of the present invention. The display device 70 according to this embodiment includes a flexible body 72 having an outer surface 74, an inner surface 76, and a periphery 78 extending around the body and surrounding the inner surface and the outer surface. The outer surface 74 may include a convex portion 80. The inner surface 76 includes a concave portion 82 opposite the outer surface 74. For embodiments in which the outer surface 74 includes the convex portion 80, the concave portion 82 of the inner surface 76 may be opposite the convex portion. The outer surface 74 may be substantially free of protrusions. In one embodiment, the convex portion 80 is substantially free of protrusions. The flexible body has a thickness (similar to the thickness T shown in FIG. 2) measured between the outer surface 74 and the inner surface 76. The thickness may vary throughout the flexible body 72 or be generally constant.

The device 70 further includes a display 84 formed on the outer surface 74 of the flexible body 72, on the inner surface 76 of the flexible body, and/or between the inner surface and the outer surface. In some embodiments, the display device 70 is substantially free of parts other than the flexible body 72 and the display 84 formed thereon. Devices 70 according to those embodiments are said to be unitary because they comprise a single body 72 and are substantially free of parts other than the body and display 84 formed thereon, such as adhesives, magnets, or rigid placards that are a part of some conventional display devices.

The device 70 may include a variety of displays 84 without departing from the scope of the present invention. For example, the display 84 may be related to one or more subjects or themes. The themes that the display 84 can relate to are not limited and exemplary themes include advertising, entertainment, education, art, geography, animals, video games, and nature. Displays 84 relating to the theme of art include but are not limited to aesthetic displays. Other exemplary themes include identification of a person, place, or thing, providing instructions or directions, inspiration (e.g., inspirational quotations), affiliations such as nationality (e.g., the display includes a flag), school, or organization, and history such as American history. The display 84 shown in FIGS. 5A and 5B is related to multiple themes including, but not limited to, business, real estate, and advertising (i.e., advertising a company, “Many Mansions Home Builders, Inc.”).

The display 84 may include a front component 86 formed on the outer surface 74 of the flexible body 72 and/or a back component 88 formed on the inner surface 76 of the flexible body. For embodiments having the front component 86 formed on the outer surface 74 and the back component 88 formed on the inner surface 76, the front and back components may relate to one or more of the same themes. The front component 86 and the back component 88 may relate to one or more different themes. As shown in FIGS. 5A and 5B, the front component 86 of the display 84 comprises parts 90 of a house including windows and a door and a company name 92. The front component 86 relates to the business, real estate, and advertising themes as described above. As shown in FIG. 5B, the back component 88 includes contact information for the company identified in the front component 86. The back component 88 relates to at least the themes of the front component 86 described above (i.e., business, real estate, and advertising).

Displays including an individual, such as the display 30 shown in FIG. 1A having the hockey player as the individual 32, may relate to one or more themes. For example, the display 30 shown in FIG. 1A relates to many themes including sports, the sport of ice hockey, and advertising (e.g., advertising the hockey player and the hockey team 38). The individual 32 and any information formed adjacent the individual, being formed on the outer surface 14 of the flexible body 12, may be referred to as the front component of the display 30. The information 34 formed on the inner surface 16 of the flexible body 12 may be referred to as the back component and, by including data about the individual 32 shown on the outer surface 14, relates to some of the same themes that the front component relates to. For example, the information 34 formed on the inner surface 16 relates to sports, ice hockey, and advertising, which are among the themes that the front component of the display 30 formed on the outer surface 14 of the flexible body relate to. As described above, the individual 32 may be formed on the inner surface 16 (i.e., as the back component of the display 30) and the information 34 about the individual may be formed on the outer surface 14 (i.e., as the front component of the display).

As another example of various display components having common themes, FIGS. 4A and 4B show a component of the display 60 formed on the inner surface 56 of the display device 50 (i.e., the back component) that relates to some of the same themes that a component of the display on the outer surface 54 (i.e., the front component) relates to. For example, both components of the display 60 relate to themes including entertainment, cinema, and advertising (e.g., advertising the actor or the films in which he has acted).

As described above, the shape of the flexible body 72, the color of the body, and the theme(s) that the display 84 relates to (or any subset of the body shape, the body color, and the theme) may be selected to relate to each other. For example, the display 84 shown in FIG. 5A comprises parts 90 of a house including windows and a door and the periphery 78 is shaped as a house. In this embodiment, the display 84 and the periphery 78 shape relate to at least one common theme (e.g., real estate and construction). As another example (not shown), the display 84 may relate to a theme of package delivery services and the periphery 78 may be shaped as a mailbox, delivery truck, or airplane. In yet another example (not shown), the display 84 may relate to a sport and the periphery 78 may have a shape corresponding to the sport such as being shaped as a ball or other item used in the sport or shaped as a player playing the sport. For example, the periphery 78 may be shaped as a golfer or surfer and the theme can be sports in general or golf or surfing, respectively, in particular. The display device 70 of this embodiment is otherwise identical to display devices of earlier described embodiments and therefore will not be described in further detail.

When introducing elements of the present invention or the preferred embodiment(s) thereof, the articles “a”, “an”, “the”, and “said” are intended to mean that there are one or more of the elements. The terms “comprising”, “including”, and “having” are intended to be inclusive and mean that there may be additional elements other than the listed elements.

As various changes could be made in the above constructions without departing from the scope of the invention, it is intended that all matter contained in the above description or shown in the accompanying drawings shall be interpreted as illustrative and not in a limiting sense.

What is claimed is:

1. A display device mountable by suction on a generally smooth mounting surface comprising:
a deformable body having an outer surface, an inner surface having a concave portion opposite said outer surface, and a periphery extending around the deformable body and surrounding the outer surface and the inner surface, wherein the body is deformable from an undeformed shape to an actuated shape to mount the display device on the mounting surface by positioning the inner surface of the body adjacent the mounting surface when the body is in its undeformed shape thereby forming a cavity between the body and the mounting surface and deforming the body to its actuated shape thereby sealing the body against the mounting surface and forcing fluid out of the cavity to create a suction between the body and the mounting surface thereby securing the body to the mounting surface; and
a display formed on the deformable body including an image.

2. A display device as set forth in claim 1 wherein said display is formed on at least one surface of the deformable body selected from a group of surfaces consisting of the outer surface and the inner surface.

3. A display device as set forth in claim 1 wherein said display is formed on the deformable body between the outer surface and the inner surface.

4. A display device as set forth in claim 1 wherein said display is formed on the deformable body by at least one method selected from a group of methods consisting of printed, molded, melted, etched, engraved, doped, and impressed.

5. A display device as set forth in claim 1 wherein said image includes a person.

6. A display device as set forth in claim 1 wherein said image includes a cartoon character.

7. A display device as set forth in claim 1 wherein said display includes an individual and information relating to said individual.

8. A display device as set forth in claim 1 wherein said display is formed on the inner surface and the outer surface of the deformable body.

9. A display device as set forth in claim 8 wherein said display includes an individual formed on the outer surface of the deformable body and information relating to said individual formed on the inner surface of the deformable body.

10. A display device as set forth in claim 1 wherein said periphery has a shape corresponding to said image.

11. A display device mountable by suction on a generally smooth mounting surface comprising:
a deformable body having an outer surface, an inner surface having a concave portion opposite said outer surface, and a periphery extending around the deformable body and surrounding the outer surface and the inner surface, wherein the body is deformable from an undeformed shape to an actuated shape to mount the display device on the mounting surface by positioning the inner surface of the body adjacent the mounting surface when the body is in its undeformed shape thereby forming a cavity between the body and the mounting surface and deforming the body to its actuated shape thereby sealing the body against the mounting surface and forcing fluid out of the cavity to create a suction between the body and the mounting surface thereby securing the body to the mounting surface; and
a display having a front component formed on the outer surface of the deformable body, the front component relating to a theme.

12. A display device as set forth in claim 11 wherein said display is formed on the deformable body by at least one method selected from a group of methods consisting of printed, molded, melted, etched, engraved, doped, and impressed.

13. A display device as set forth in claim 11 wherein said display has a back component of said display formed on the inner surface of the deformable body, the back component relating to said theme.

14. A display device as set forth in claim 13 wherein said front component of the display includes an individual and said back component of the display includes information about the individual.

15. A display device as set forth in claim 11 wherein said theme comprises entertainment.

16. A display device as set forth in claim 11 wherein said theme comprises sports.

17. A display device as set forth in claim 11 wherein said theme comprises advertising.

18. A display device as set forth in claim 11 wherein said theme comprises art.

19. A display device as set forth in claim 11 wherein said periphery has a shape corresponding to said theme.

20. A display device mountable by suction on a generally smooth mounting surface comprising:
a deformable body having an outer surface, an inner surface having a concave portion opposite said outer surface, and a periphery extending around the deformable body and surrounding the outer surface and the inner surface, wherein the body is deformable from an undeformed shape to an actuated shape to mount the display device on the mounting surface by positioning the inner surface of the body adjacent the mounting surface when the body is in its undeformed shape thereby forming a cavity between the body and the mounting surface and deforming the body to its actuated shape thereby sealing the body against the mounting surface and forcing fluid out of the cavity to create a suction between the body and the mounting surface thereby securing the body to the mounting surface; and
a display having a back component formed on the inner surface of the deformable body, the back component relating to a theme.

21. A display device as set forth in claim 20 wherein said display is formed on the deformable body by at least one method selected from a group of methods consisting of printed, molded, melted, etched, engraved, doped, and impressed.

22. A display device as set forth in claim 20 wherein said display has a front component formed on the outer surface of the deformable body, the front component relating to said theme.

23. A display device as set forth in claim 22 wherein said back component of the display includes an individual and said front component of the display includes information about the individual.

24. A display device as set forth in claim 20 wherein said periphery has a shape corresponding to said theme.
